(19) United States
(12) Patent Application Publication
(10) Pub. No.: US 2014/0066528 A1
(43) Pub. Date: Mar. 6, 2014

(54) ANION EXCHANGE MEMBRANE AND PRODUCING METHOD THEREOF

(71) Applicants: Daihatsu Motor Co., Ltd., Osaka (JP); Japan Atomic Energy Agency, Ibaraki (JP)

(72) Inventors: Kimio YOSHIMURA, Gunma (JP); Hiroshi KOSHIKAWA, Gunma (JP); Tetsuya YAMAKI, Gunma (JP); Masaharu ASANO, Gunma (JP); Yasunari MAEKAWA, Gunma (JP); Hideyuki SHISHITANI, Gamo-gun Shiga (JP); Koichiro ASAZAWA, Gamo-gun Shiga (JP); Susumu YAMAGUCHI, Gamo-gun Shiga (JP); Hirohisa TANAKA, Gamo-gun Shiga (JP)

(73) Assignees: Daihatsu Motor Co., Ltd., Osaka (JP); Japan Atomic Energy Agency, Ibaraki (JP)

(21) Appl. No.: 14/012,071

(22) Filed: Aug. 28, 2013

(30) Foreign Application Priority Data
Aug. 31, 2012 (JP) 2012-192620

(51) Int. Cl. C08F 26/06

(52) U.S. Cl. CPC C08F 26/06
USPC 521/27

(57) ABSTRACT

A graft chain containing an N-vinylimidazole derivative is introduced into a polymer substrate by radiation graft polymerization to obtain an alkyl substituted imidazolium salt by a reaction with an alkyl halide, so that an anion exchange membrane with high alkaline durability, in which a nucleophilic substitution reaction and an elimination reaction are inhibited, is obtained.

### FIELD

The present invention relates to an anion exchange membrane used in a solid polymer electrolyte fuel cell, and a producing method thereof. For further details, the present invention relates to an anion exchange membrane with high conductivity, low water uptake and high alkaline durability, characterized in that a vinylimidazolium salt is contained in a graft chain introduced into a polymer substrate, and a producing method thereof.

### BACKGROUND

A proton conductive fuel cell using hydrogen as a fuel is so high in power generation efficiency as to become a promising solution to the exhaustion of fossil fuel, and may reduce the emission of carbon dioxide so vastly as to become a means of deterring global warming; therefore, the development thereof is desired as a power source for domestic cogeneration and automobiles. Above all, particularly, a solid polymer fuel cell is low in operating temperature, is small in resistance of an electrolyte, and uses a catalyst with high activity, so that the solid polymer fuel cell allows high output even though a small size and practical use thereof at an early stage is expected.

On the other hand, an anion conductive fuel cell using methanol and hydrazine hydrate as a fuel is simple and safety of mounting as a liquid fuel and power density that the application to fuel cell powered vehicles is promoted while particularly focusing on compact cars. In this system, the strong acid condition in the proton conductive fuel cell is not required during operation, so that the system is characterized most greatly in that not a noble metal such as platinum but inexpensive iron and cobalt, which may not be utilized in the proton conductive fuel cell by reason of being dissolved in the strong acid condition, may be utilized for an electrode. Accordingly, a low-cost and high-output fuel cell may be expected. However, the present situation is such that an anion exchange membrane of practical use is hardly developed, and the present anion exchange membrane has the largest problem in lowness of performance such as conductivity, mechanical strength and fuel permeability, and durability such as remarkably low alkaline durability as compared with a proton exchange membrane with favorable results of utilization, starting with Nafion (registered trademark).

In the anion conductive fuel cell, the anion exchange membrane functions as the so-called ‘electrolyte’ for conducting a hydroxide ion (an anion), and as ‘separator’ for not directly mixing methanol and hydrazine as a fuel with oxygen. This polymer electrolyte membrane requires that ion conductivity be high, chemical stability and heat resistance be exhibited for enduring a long-term use in an alkali aqueous solution at a high temperature (>60° C.) as the operating condition of the cell, and water retentivity of the membrane be constant for keeping ion conductivity high. On the other hand, it is required by reason of a role as the separator that mechanical strength and dimensional stability of the membrane be excellent, and high barrier property against methanol, hydrazine and oxygen be exhibited.

Then, the development of the anion exchange membrane for solving the above-mentioned problems has been actively promoted until now. For example, the anion exchange membrane, in which a hydrocarbon film such as porous polyethylene is used as a substrate to fill cross-linked anion exchange resin into pores thereof, is developed and put on the market (JP-A No. 2002-367626, 2009-203455, and 2010-92660). Also, a producing method of the anion exchange membrane, in which a polymerization product of a mixture of haloalkyl styrene, elastomer and an epoxy compound is used as a substrate membrane to introduce an anion exchange group by a quaternization reaction (JP-A No. 2011-202074), and a producing method of the anion exchange membrane, in which radiation graft polymerization of an anion exchange group precursor monomer and thereafter an anion exchange group are introduced to a substrate made of a fluorine polymer (JP-A No. 2000-331693), are proposed.

### SUMMARY OF THE INVENTION

The existing anion exchange membrane has been very high water uptake and has not had strength for enduring use for the reason that an anion exchange group therein is an alkylammonium salt obtained by quaternizating alkylamine such as mainly trimethylamine. Also, the anion exchange membrane using a partial imidazolium salt, in which basicity of an anion conductive site is decreased, as an anion exchange group has been reported and has not been sufficient in alkaline durability.

Accordingly, the object of the present invention is to provide an anion exchange membrane with favorable conductivity, water uptake property and alkaline durability, and a producing method thereof.

According to an aspect of the present invention, the anion exchange membrane of the present invention comprises a polymer substrate comprising a graft chain having an alkyl substituted imidazolium salt as an ion exchange group, and the graft chain is formed by N-alkylating an imidazole site of a polymer containing an N-vinylimidazole derivative as a polymerization unit with an alkyl halide with a carbon number of 3 or more.

According to another aspect of the present invention, the graft chain salt may be the polymer having the polymerization unit represented by the following formula (1):

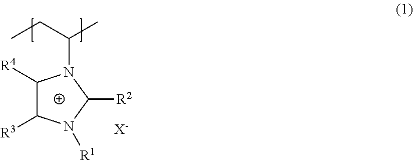

wherein, R¹ is an alkyl group with a carbon number of 3 or more; R², R³ and R⁴ may be each the same or different, and denote a hydrogen atom, a cyano group or a hydrocarbon group optionally having a substituent; and X⁻ is a negative ion.

According to another aspect of the present invention, the graft chain may be a copolymer further containing a comonomer as the polymerization unit.

According to another aspect of the present invention, the polymerization unit of the above-mentioned comonomer may be represented by the following formula (2):

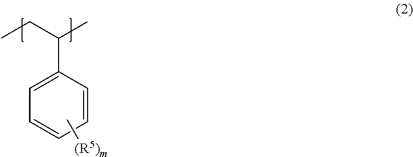

wherein, R⁵ denotes a hydrogen atom, a halogen atom or an alkyl group optionally having a substituent; m is an integer of 1 to 5; and when m is 2 or more, R⁵ may be the same or different.

According to a further aspect of the present invention, a producing method of the anion exchange membrane of the present invention comprises the following steps:

step A: step of graft-polymerizing an N-vinylimidazole derivative with a polymer substrate to introduce a polymer of the above-mentioned N-vinylimidazole derivative as a graft chain into the above-mentioned polymer substrate; and

step B: step of N-alkylating an imidazole site of the above-mentioned graft chain with an alkyl halide with a carbon number of 3 or more to form an alkyl substituted imidazolium salt.

According to another aspect of the present invention, the above-mentioned N-vinylimidazole derivative may be a vinyl monomer having an imidazole ring capable of forming the alkyl substituted imidazolium salt by reacting with the alkyl halide.

According to another aspect of the present invention, the above-mentioned N-vinylimidazole derivative may be a vinyl monomer represented by the following formula (3):

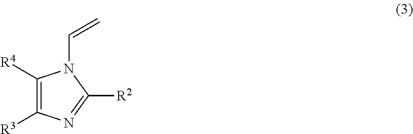

wherein, R², R³ and R⁴ may be each the same or different, and denote a hydrogen atom, a cyano group or a hydrocarbon group optionally having a substituent.

According to another aspect of the present invention, in the above-mentioned step A, a copolymer of the above-mentioned N-vinylimidazole derivative and a comonomer may be introduced as the graft chain into the above-mentioned polymer substrate by graft-polymerizing the above-mentioned N-vinylimidazole derivative and the above-mentioned comonomer with the polymer substrate.

According to another aspect of the present invention, the above-mentioned comonomer may be a vinyl monomer represented by the following formula (4):

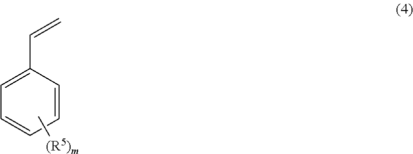

wherein, R⁵ denotes a hydrogen atom, a halogen atom or an alkyl group optionally having a substituent; m is an integer of 1 to 5; and when m is 2 or more, R⁵ may be the same or different.

The anion exchange membrane of the present invention is favorable in conductivity, water uptake property and alkaline durability. Also, the producing method of the anion exchange membrane of the present invention allows the anion exchange membrane with favorable conductivity, water uptake property and alkaline durability to be industrially produced.

Thus, the present invention may solve the problems in a conventional anion conductive polymer fuel cell, which result from alkaline fission of the anion exchange membrane.

### BRIEF DESCRIPTION OF THE DRAWINGS

FIG. 1 is a view showing synthesis and conjugated structure of an iminium salt by an N-alkylation reaction of 1,3-diaza compound;

FIG. 2 is a view showing a difference in structure between an anion exchange membrane of the present invention and a conventional membrane; and

FIG. 3 is a schematic view showing a relation of a polymer substrate, a graft chain and an ion exchange group in an anion exchange membrane.

### DETAILED DESCRIPTION

An anion exchange membrane of the present invention has an alkyl substituted imidazolium salt as an ion exchange group in a graft chain of a polymer substrate, as described above.

Here, the graft chain of a polymer substrate is formed by radiation graft polymerization of an N-vinylimidazole derivative as a monomer, for example. This graft chain may be constituted as a homopolymer of the N-vinylimidazole derivative. Also, the graft chain may be constituted as a copolymer of the N-vinylimidazole derivative and a comonomer by radiation graft polymerization of the N-vinylimidazole derivative and the comonomer. The N-vinylimidazole derivative is a vinyl monomer having an imidazole ring capable of forming the alkyl substituted imidazolium salt by reacting with an alkyl halide, as described later. The comonomer is a vinyl monomer such as a hydrocarbon vinyl monomer and a fluorocarbon vinyl monomer, as described later. When this comonomer is introduced as a polymer unit into the graft chain, the comonomer functions as a spacer and the repulsion of positive charges with each other in the alkyl substituted imidazolium salt decreases. Thus, an elimination reaction is inhibited. As a result, the anion exchange membrane with high conductivity and high alkaline durability is obtained.

The above-mentioned alkyl substituted imidazolium salt is formed by N-alkylating an imidazole site of the above-mentioned graft chain with an alkyl halide with a carbon number of 3 or more. That is to say, this alkyl substituted imidazolium salt is a salt comprising an imidazolium cation and an anion. The imidazolium cation is such that an alkyl group with a carbon number of 3 or more is bonded to a 3-position nitrogen atom on the imidazole ring derived from the above-mentioned N-vinylimidazole derivative.

Such an anion exchange membrane may be represented as a substance including a structural unit having the alkyl substituted imidazolium salt, for example, as is represented by the following formula (1) as a polymerization unit composing the graft chain of a polymer substrate thereof.

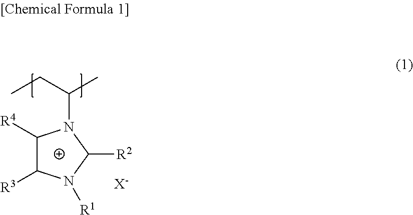

Here, in the formula (1), R¹ is an alkyl group with a carbon number of 3 or more. R², R³ and R⁴ may be each the same or different, and denote a hydrogen atom, a cyano group or a hydrocarbon group optionally having a substituent. X⁻ is a negative ion.

The alkyl group of R¹ may be any of a straight chain, a branched chain and a ring. The carbon number of the alkyl group may be 3 or more and 10 or less, for example. The carbon number is preferably 3 or more and 8 or less, more preferably 3 or more and 6 or less for realizing the intended object of the present invention.

Specific examples of the alkyl group include alkyl groups of a straight chain, a branched chain or a ring, such as a methyl group, an ethyl group, an n-propyl group, an iso-propyl group, an n-butyl group, an iso-butyl group, a sec-butyl group, a tert-butyl group, an n-pentyl group, an iso-pentyl group, a sec-pentyl group, a tert-pentyl group, a neopentyl group, an n-hexyl group, an iso-hexyl group, a 3-methylpentyl group, a 2-methylpentyl group, a 1-methylpentyl group, a 1-ethylbutyl group, a 2-ethylbutyl group, a 1,2-dimethylbutyl group, a 2,3-dimethylbutyl group, an n-heptyl group, an n-octyl group, an n-nonyl group, an n-decyl group, a cyclohexyl group, a cyclopentylmethyl group, and a cyclohexylmethyl group.

The hydrocarbon group of R² to R⁴ is an alkyl group and an aromatic hydrocarbon group, for example. The alkyl group may be any of a straight chain, a branched chain and a ring. The carbon number of the hydrocarbon group is, for example, 1 or more and 10 or less, preferably 1 or more and 6 or less. The hydrocarbon group may have a hydroxyl group, a cyano group and a carboxyl group as a substituent by one piece or plural pieces.

X⁻ is a counterion of the alkyl substituted imidazolium salt. The counterion is a halogen ion such as a chloride ion, a bromide ion and an iodide ion. The halogen ion may be properly substituted with a hydroxide ion, a carbonate ion, a bicarbonate ion and the like in accordance with uses of the anion exchange membrane.

In the case where the graft chain of a polymer substrate is constituted by a copolymer of the N-vinylimidazole derivative and a comonomer, particularly, in the case where the comonomer is a styrene-based monomer, the graft chain of a polymer substrate in the anion exchange membrane may be represented as a substance including a structural unit represented by the above-mentioned formula (1) and a structural unit represented by the following formula (2), for example,

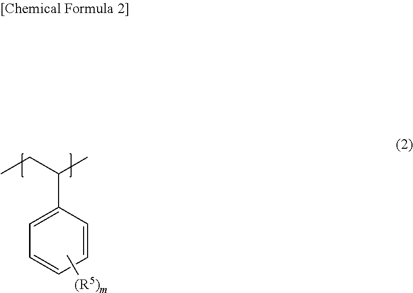

Here, in the formula (2), R⁵ denotes a hydrogen atom, a halogen atom or an alkyl group optionally having a substituent. m is an integer of 1 to 5. When m is 2 or more, R⁵ may be the same or different.

The alkyl group of R⁵ may be any of a straight chain, a branched chain and a ring. The carbon number of the alkyl group may be, for example, 1 or more and 20 or less, preferably 1 or more and 10 or less. The alkyl group may have a substituent such as a halogen group.

In the anion exchange membrane, it is conceived that membrane resistance is decreased by thinning the membrane thickness for improving conductivity. However, in the present situation, the anion exchange membrane with a membrane thickness in a range of 30 μm to 200 μm is ordinarily used for the reason that too thin membrane thickness of the anion exchange membrane damages the anion exchange membrane easily. In the present invention, the anion exchange membrane with a membrane thickness in a range of 5 μm to 200 μm is useful.

The anion exchange membrane of the present invention may be produced by a method comprising:

(A) step of performing radiation graft polymerization of an N-vinylimidazole derivative to a polymer substrate to introduce a polymer of the above-mentioned N-vinylimidazole derivative as a graft chain into the above-mentioned polymer substrate; and

(B) step of N-alkylating an imidazole site of the above-mentioned graft chain with an alkyl halide with a carbon number of 3 or more to form an alkyl substituted imidazolium salt.

First, step (A) is described.

In step (A), as described above, the polymer of the N-vinylimidazole derivative is introduced as the graft chain into the polymer substrate.

Here, a polymer substrate made of a fluorine polymer, a polymer substrate made of an olefin polymer, and a polymer substrate made of an aromatic polymer are used as the polymer substrate.

Examples of the fluorine polymer include polytetrafluoroethylene (hereinafter abbreviated as PTFE), tetrafluoroethylene-hexafluoropropylene copolymer (hereinafter abbreviated as FEP), tetrafluoroethylene-perfluoroalkylvinyl ether copolymer (hereinafter abbreviated as PFA), polyvinylidene fluoride (hereinafter abbreviated as PVDF), ethylene-tetrafluoroethylene copolymer (hereinafter abbreviated as ETFE), polyvinyl fluoride (hereinafter abbreviated as PVF), and polychloro-trifluoroethylene copolymer (hereinafter abbreviated as PCTFE). In the case of using the polymer substrate made of the fluorine polymer, previous crosslinking of the fluorine polymer allows heat resistance and swelling inhibitory capacity of the anion exchange membrane to be further improved.

Examples of the olefin polymer include polyethylene and polypropylene with low density, high density and ultra high molecular weight. Also, examples thereof include a polymer having trimethylpentene as a polymerization unit. In the case of using the polymer substrate made of the olefin polymer, previous cross-linking of the olefin polymer allows heat resistance and swelling inhibitory capacity of the anion exchange membrane to be further improved.

Examples of the aromatic polymer include polyimide, polyamideimide, polyetherimide, polyethylene naphthalate, liquid crystalline aromatic polymer, polyether ether ketone, polyphenylene oxide, polyphenylene sulfide, polysulfone, and polyether sulfone, which are referred to as high-performance resin (super engineering plastic). In the case of using the polymer substrate made of the aromatic polymer, previous cross-linking of the aromatic polymer allows heat resistance and swelling inhibitory capacity of the electrolyte membrane to be further improved.

Incidentally, a composite material of thermoplastic resin and various kinds of inorganic fillers, or a polymer alloy may be also used as the polymer substrate for the purpose of durability improvement and swelling inhibition of the anion exchange membrane.

A vinyl monomer having an imidazole ring capable of forming the alkyl substituted imidazolium salt by reacting with an alkyl halide is used as the N-vinylimidazole derivative. For example, the vinyl monomer represented by the following formula (3) may be used.

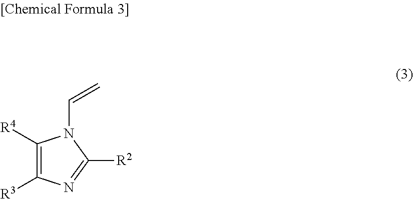

Here, in the formula (3), R², R³ and R⁴ may be each the same or different, and denote a hydrogen atom, a cyano group or a hydrocarbon group optionally having a substituent, R², R³ and R⁴ of this formula (3) correspond to R², R³ and R⁴ of the formula (1), respectively.

Specific examples of the N-vinylimidazole derivative include N-vinylimidazole, N-vinyl-2-methylimidazole, 4,5-dicyano-N-vinylimidazole, 4,5-diphenyl-N-vinylimidazole, and 4,5-dihydroxymethyl-N-vinylimidazole.

The radiation graft polymerization may be performed by a publicly known method. Examples thereof include a pre-irradiation method such that the polymer substrate is previously irradiated, subsequently contacted with the N-vinylimidazole derivative and subjected to graft polymerization. The pre-irradiation method is preferable for the reason that the produced amount of a homopolymer is small. Examples of the pre-irradiation method include a polymer radical method of irradiating the polymer substrate in an inert gas and a peroxide method of irradiating the polymer substrate in the presence of oxygen; both of them are usable.

The irradiation on the polymer substrate is preferably performed by 1 to 500 kGy at a temperature from room temperature to 150° C. in the presence of an inert gas or oxygen. An irradiation amount of 1 kGy or less makes it difficult to allow graft rate necessary for obtaining sufficient conductivity, while an irradiation amount of 500 kGy or more occasionally makes the polymer substrate fragile.

The graft polymerization of the N-vinylimidazole derivative is performed by immersing the polymer substrate irradiated on the above-mentioned conditions in a solution containing the N-vinylimidazole derivative (hereinafter, also referred to as a monomer solution).

The monomer solution is preferably a solution diluted with an organic solvent from the viewpoint of graft polymerizability of the polymer substrate and membranous shape maintenance of the graft polymer substrate obtained by the graft polymerization in the monomer solution. Examples of the organic solvent include dichloroethane, chloroform, N-methylformamide, N-methylacetamide, N-methylpyrrolidone, γ-butyrolactone, n-hexane, methanol, ethanol, 1-propanol, t-butanol, toluene, xylene, cyclohexane, cyclohexanone, and dimethylsulfoxide. Such solvents may be used singly or used together.

It is desirable that the graft rate be 5 to 200% by weight, preferably 30 to 130% by weight with respect to the polymer substrate. A graft rate of 5% by weight or less makes it difficult to maintain necessary conductivity as a fuel cell. A graft rate of 200% by weight or more brings high water uptake as to occasionally make it difficult to maintain strength and dimensional stability of the anion exchange membrane.

The radiation graft polymerization is not limited to the above-mentioned pre-irradiation method. For example, the radiation graft polymerization may be also performed by a simultaneous irradiation method such that the polymer substrate and the N-vinylimidazole derivative are simultaneously irradiated and subjected to graft polymerization.

As described above, a polymer of the N-vinylimidazole derivative is introduced as the graft chain into the polymer substrate. This graft chain is a homopolymer of the N-vinylimidazole derivative, and a copolymer of the N-vinylimidazole derivative and a comonomer may be also introduced as the graft chain into the polymer substrate by performing radiation graft polymerization for the N-vinylimidazole derivative and the comonomer. With regard to the anion exchange membrane produced by using the polymer substrate into which such a copolymer is introduced as the graft chain, a site of the comonomer of the copolymer functions as a spacer, and an elimination reaction is inhibited by a decrease in the repulsion of positive charges with each other in the alkyl substituted imidazolium salt. As a result, the anion exchange membrane with high conductivity and high alkaline durability is obtained.

In order to obtain such an anion exchange membrane, the introduction amount of the comonomer is preferably less than 70% by weight in the copolymer of the N-vinylimidazole derivative and the comonomer. In the case where the introduction amount of the comonomer is 70% by weight or more, the content of the alkyl substituted imidazolium salt occasionally decreases to deteriorate conductivity.

The same method as the above-mentioned radiation graft polymerization is considered for a method of introducing the copolymer of the N-vinylimidazole derivative and the comonomer as the graft chain into the polymer substrate. For example, first, the polymer substrate is irradiated. Subsequently, this polymer substrate is immersed in the monomer solution in which the N-vinylimidazole derivative and the comonomer are mixed. Thus, the polymer substrate into which the copolymer of the N-vinylimidazole derivative and the comonomer is introduced as the graft chain is obtained.

The comonomer is not particularly limited if the comonomer is a vinyl monomer capable of decreasing the repulsion of positive charges with each other in the alkyl substituted imidazolium salt of the finally obtained anion exchange membrane. For example, a styrene-based monomer represented by the following formula (4) may be used as the comonomer.

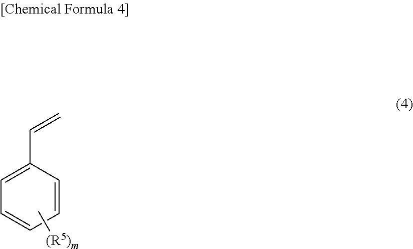

Here, in the formula (4), R⁵ denotes a hydrogen atom, a halogen atom or an alkyl group optionally having a substituent. m is an integer of 1 to 5. When m is 2 or more, R⁵ may be the same or different. R⁵ of this formula (4) corresponds to R⁵ of the formula (2).

The comonomer is not limited to the styrene-based monomer as described above, but a vinyl monomer such as a hydrocarbon vinyl monomer and a fluorocarbon vinyl monomer may be also used.

Examples of the above-mentioned hydrocarbon vinyl monomer include acrylonitrile, vinyl ketone, isobutene, butadiene, isoprene, and acetylene derivative except styrene.

Examples of the above-mentioned fluorocarbon vinyl monomer include heptafluoropropyltrifluorovinyl ether, ethyltrifluorovinyl ether, hexafluoropropene, perfluoro(propylvinyl ether), pentafluoroethyltrifluorovinyl ether, perfluoro(4-methyl-3,6-dioxanone-1-ene), trifluoromethyltrifluorovinyl ether, and hexafluoro-1,3-butadiene.

In step (A), the graft chain may be cross-linked by using a cross-linking agent such as a polyfunctional monomer together in performing radiation graft polymerization. Examples of the polyfunctional monomer include bis(vinylphenyl)ethane, divinylbenzene, 2,4,6-triallyloxy-1,3,5-triazine(triallyl cyanurate), triallyl-1,2,4-benzenetricarboxylate (triallyl trimellitate), diallyl ether, bis(vinylphenyl)methane, divinyl ether, 1,5-hexadiene, and butadiene.

With regard to the anion exchange membrane produced by using the cross-linking agent together, a chemical bond increases by cross-linking, so that mechanical strength increases. As a result, the deformation of the anion exchange membrane due to hydrous swelling may be decreased, and the deterioration of the anion exchange membrane may be inhibited in a fuel cell operating state. In order to obtain such an anion exchange membrane, the cross-linking agent is preferably used so that the weight ratio to the N-vinylimidazole derivative becomes 20% or less. The use by more than 20% occasionally makes the anion exchange membrane fragile.

Next, step (B) is described.

In step (B), as described above, an imidazole site of the graft chain is N-alkylated with an alkyl halide with a carbon number of 3 or more to form an alkyl substituted imidazolium salt. Thus, the anion exchange membrane is obtained.

An alkyl halide represented by the following formula (5) is used for the alkyl halide.

R¹−X (5)

Here, in the formula (5), R¹ is an alkyl group with a carbon number of 3 or more. X denotes a chlorine atom, a bromine atom and an iodine atom. R¹ of this formula (5) corresponds to R¹ of the formula (1).

Such an alkyl halide may be used singly or used together. Propyl iodide and butyl iodide are preferably used from the viewpoint of reactivity of the alkyl halide and hydrophobic property of the alkyl group.

The N-alkylation of an imidazole site of the graft chain may be performed by reacting the polymer substrate, into which the graft chain is introduced, with a solution of the alkyl halide, which is diluted with an organic solvent.

Examples of the organic solvent include alcohols such as methanol, ethanol and propanol, ethers such as dioxane, and aromatic hydrocarbons such as toluene and xylene. Such organic solvents may be used singly or used together. The concentration of the solution of the alkyl halide is preferably 1 to 5 mol/L, for example. The reaction time is, for example, 2 to 48 hours, preferably 6 to 24 hours. The reaction temperature is, for example, 5 to 100° C., preferably 50 to 95° C.

After the N-alkylation, the polymer substrate is immersed in acetone as required. Thus, the excessive alkyl halide may be removed. Thereafter, the polymer substrate may be washed again in acetone and dried in a vacuum.

With regard to the anion exchange membrane thus obtained, the reaction yield of the N-alkylation is 90 to 100%, for example.

The anion exchange membrane thus produced has a halogen ion as a counterion of the imidazolium salt. The halogen ion may be properly substituted with a hydroxide ion, a carbonate ion, a bicarbonate ion and the like in accordance with uses of the anion exchange membrane. For example, in the case of using the anion exchange membrane for a solid polymer fuel cell, the counterion is substituted with a hydroxide ion instead of the halogen ion. The substitution of the halogen ion with a hydroxide ion is such that the anion exchange membrane having the halogen ion as the counterion is immersed in a basic solution to substitute the counterion with a hydroxide ion instead of the halogen ion. Examples of the basic solution include an aqueous solution of sodium hydroxide, potassium hydroxide and the like. Preferable examples include a potassium hydroxide aqueous solution among such basic solutions. The concentration of the basic solution is 0.1 to 5 mol/L, for example. Such hydroxide solutions may be used singly or used together. The immersion conditions are such that the immersion time is 5 to 48 hours and the immersion temperature is 5 to 60° C.

Thus, the anion exchange membrane having the alkyl substituted imidazolium salt as an ion exchange group in the graft chain of the polymer substrate is produced. This anion exchange membrane is favorable in conductivity, water uptake property and alkaline durability.

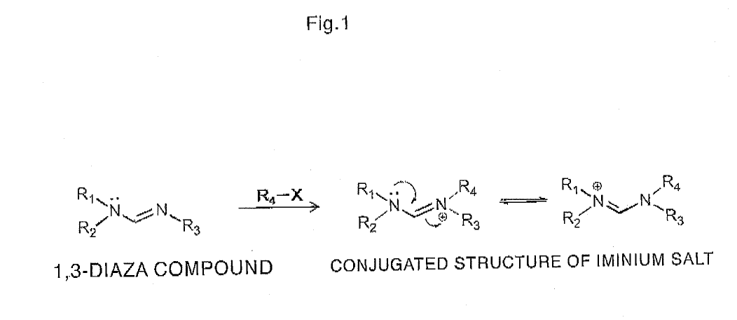

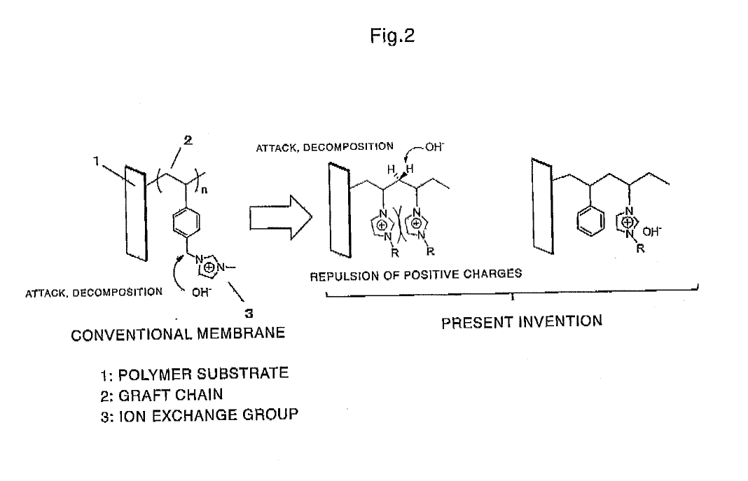

The ion exchange group of the conventional anion exchange membrane has been very unstable by reason of being an alkylammonium hydroxide salt with strong basicity. Thus, the conventional anion exchange membrane has exhibited high water uptake. On the contrary, with regard to the anion exchange membrane of the present invention, the ion exchange group is the alkyl substituted imidazolium salt (an iminium salt) obtained by the N-alkylation of imidazole as 1,3-diaza compound. As shown in FIG. 1, positive charges are dispersed by the conjugated structure of the iminium salt, and the basicity of the imidazolium hydroxide salt may be controlled to a low level. As a result, the stabilization (lower water uptake) of the anion exchange membrane may be intended. Incidentally, in FIG. 1, R¹ to R⁴ denote an alkyl group optionally having a substituent, and X denotes a chlorine atom, a bromine atom and an iodine atom. Also, with regard to the anion exchange membrane of the present invention, the alkyl substituted imidazolium salt is directly introduced into the graft chain of the polymer substrate. Thus, as shown in FIG. 2, the deterioration due to a nucleophilic substitution reaction, which has been caused in the conventional anion exchange membrane having a benzylic type structure, may be inhibited. In addition, as shown in FIG. 2, the copolymerization of a vinyl monomer, such as styrene, as a spacer with the graft chain of the polymer substrate allows an elimination reaction to be inhibited by a decrease in the repulsion of positive charges with each other. As a result, conductivity and alkaline durability may be further improved, and the anion exchange membrane with high conductivity and high alkaline durability may be realized.

### EXAMPLES

The present invention is hereinafter described by examples and comparative examples, and is not limited thereto.

### Example 1

An ETFE membrane with a film thickness of 50 μm (manufactured by Asahi Glass Co., Ltd.) was irradiated with γ rays of 50 kGy under an argon atmosphere at room temperature, and thereafter immersed in a xylene solution of N-vinylimidazole (NVIm) (NVIm:xylene=1:1) for 18 hours in a constant temperature bath of 60° C. to perform graft polymerization of N-vinylimidazole with the ETFE main chain (a graft rate of 52%).

The obtained graft membrane and a dioxane solution of propyl iodide (a concentration of 1 M) were put in a screw tube and reacted in a constant temperature bath of 95° C. for 24 hours. The graft membrane was washed in acetone and thereafter dried in a vacuum to obtain a homopolymerization anion exchange membrane having a halogen ion as a counterion with a reaction yield of N-alkylation of 100%.

Subsequently, the homopolymerization anion exchange membrane was immersed in 1M-potassium hydroxide of 60° C. for 48 hours to substitute the counterion, and thereafter obtain a homopolymerization anion exchange membrane having a hydroxide ion as a counterion by repeating twice a process such as to be washed twice in deionized water, from which carbonic acid was removed by nitrogen bubbling, and immersed therein for 30 minutes.

### Example 2

A homopolymerization anion exchange membrane was obtained with a reaction yield of N-alkylation of 98% in the same manner as Example 1 except for obtaining a graft membrane with a graft rate of 80% by reacting for 30 hours.

### Example 3

A homopolymerization anion exchange membrane having a butyl group as an alkyl group was obtained with a reaction yield of N-alkylation of 100% in the same manner as Example 1 except for using a dioxane solution of butyl iodide (a concentration of 1 M) as an N-alkylating reagent.

### Example 4

An ETFE membrane with a film thickness of 50 μm (manufactured by Asahi Glass Co., Ltd.) was irradiated with γ rays of 50 kGy under an argon atmosphere at room temperature, and thereafter immersed in a 50 wt. %-xylene solution in which NVIm and styrene (St) are mixed (NVIm:St=8:2) for 18 hours in a constant temperature bath of 60° C. to perform graft polymerization of N-vinylimidazole-styrene copolymer with the ETFE main chain (a graft rate of 85%).

The obtained copolymerization graft membrane and a dioxane solution of propyl iodide (a concentration of 1 M) were put in a screw tube and reacted in a constant temperature bath of 95° C. for 24 hours. The graft membrane was washed in acetone and thereafter dried in a vacuum to obtain a copolymerization anion exchange membrane having a halogen ion as a counterion. The copolymerization ratio calculated from the amount of weight increase was NVIm:St=1:1.

Subsequently, the homopolymerization anion exchange membrane was immersed in 1M-potassium hydroxide of 80° C. for 48 hours to substitute the counterion, and thereafter obtain a copolymerization anion exchange membrane having a hydroxide ion as a counterion by repeating twice a process such as to be washed twice in deionized water, from which carbonic acid was removed by nitrogen bubbling, and immersed therein for 30 minutes.

### Example 5

A copolymerization anion exchange membrane with a copolymerization ratio of NVIm:St=1:2 was obtained in the same manner as Example 4 except for using a solution of NVIm:St=7:3 as a monomer solution and obtaining a graft membrane with a graft rate of 120% by reacting for 36 hours.

### Comparative Example 1

An ETFE membrane with a film thickness of 50 μm was irradiated with γ rays of 50 kGy under an argon atmosphere at room temperature, and thereafter immersed in a xylene solution of chloromethylstyrene (CMS) (CMS:xylene=1:1) for 2 hours in a constant temperature bath of 60° C. to perform graft polymerization of CMS with ETFE (a graft rate of 70%).

The obtained graft membrane and a methyl ethyl ketone solution of 1-methylimidazole (Mini) (10 mol %) were put in a screw tube and reacted in a constant temperature bath of 60° C. for 42 hours. The graft membrane was washed in deionized water and thereafter immersed in 1 M-hydrochloric acid for 24 hours, and thereafter immersed in deionized water for 2 hours and thereafter dried in a vacuum to obtain an anion exchange membrane having a halogen ion as a counterion with a reaction yield of quaternization of 100%.

Subsequently, the anion exchange membrane was immersed in 1 M-potassium hydroxide for 10 hours to substitute the counterion, and thereafter obtain an anion exchange membrane having a hydroxide ion as a counterion by repeating three times a process such as to be washed three times in deionized water, from which carbonic acid was removed by nitrogen bubbling, and shaken for 20 minutes.

### Comparative Example 2

An anion exchange membrane was obtained with a reaction yield of quaternization of 100% in the same manner as Comparative Example 1 except for modifying the amine solution used in Comparative Example 1 into 30%-trimethylamine (TMA) aqueous solution and reacting at room temperature for 20 hours.

### Comparative Example 3

A homopolymerization anion exchange membrane having a methyl group as an alkyl group was obtained with a reaction yield of N-alkylation of 95% in the same manner as Example 1 except for using a dioxane solution of butyl iodide (a concentration of 1 M) as an N-alkylating reagent and reacting in a constant temperature bath of 40° C. for 3 days.

Any of the reaction yields of N-alkylation and quaternization of the anion exchange membranes produced in Examples 1 to 5 and Comparative Examples 1 to 3 exceeded 90%. The reaction proceeded approximately quantitatively by optimizing kinds of the halogen of alkyl halide, kinds of the solvent, and the reaction temperature.

Each measured value of the anion exchange membranes produced in Examples 1 to 5 and Comparative Examples 1 to 3 was measured to evaluate the anion exchange membranes.

Such anion exchange membranes are preferably evaluated while originally having all hydroxide ions as counterions. However, the hydroxide ion as a counterion reacts promptly with carbon dioxide in the air to change into a bicarbonate ion. Then, in order to obtain a stable measured value, washing performed after immersion in a basic solution and measurement of electric conductivity are performed in deionized water, from which carbonic acid was removed by nitrogen bubbling.

Each measured value is measured in the following manner.

### (1) Graft Rate (%)

When a polymer substrate is regarded as a main chain portion and a part subject to graft polymerization with a vinyl monomer is regarded as a graft chain portion, the weight ratio of the graft chain portion to the main chain portion is represented by a graft rate of the following formula (X_{dg}[% by weight]).

X_{dg}=100(W₂−W₁)/W₁

W₁: weight in dry state before graft (g)

W₂: weight in dry state after graft (g)

(2) Ion Exchange Capacity (mmol/g)

The ion exchange capacity (IEC) of an anion exchange membrane is represented by the following formula.

IEC=[n(basic group)_{obs}]/W₃(mM/g)

[n(basic group)_{obs}]: basic group amount of anion exchange membrane (mM)

W₃: dry weight of anion exchange membrane (g)

The measurement of [n(basic group)_{obs}] is performed in the following manner. An anion exchange membrane with hydroxide (hereinafter referred to as OH type) is immersed in 0.1 M-hydrochloric acid solution, whose capacity is exactly measured, at room temperature for 12 hours, and substituted completely with chloride (hereinafter referred to as Cl type) to thereafter measure basic group concentration of the anion exchange membrane by back-titrating the concentration of the remaining hydrochloric acid solution with 0.1 M-NaOH.

### (3) Reaction Yield of N-alkylation (%)

The reaction yield of N-alkylation of an anion exchange membrane is represented by the following formula.

Reaction yield=100×((W₃−W₂)/M_{g2})(mol/mol)/((W₁−W₂)/M_{g})(mol/mol)

W₃: dry weight of anion exchange membrane after N-alkylation (g)

M_{g}: molecular weight of graft monomer (g/mol)

M_{g2}: molecular weight of alkyl halide (g/mol)

### (4) Water Uptake (%)

An anion exchange membrane of Cl type or OH type preserved in water at room temperature is taken out, and water on the surface thereof is lightly wiped off to thereafter measure the weight thereof (W₅ (g)). This membrane is dried in a vacuum at a temperature of 40° C. for 16 hours to thereafter measure the weight and thereby measure the dry weight W₄ (g) of the anion exchange membrane, and water uptake is calculated from W₅ and W₄ by the following formula.

Water uptake=100(W₅−W₄)/W₄

### (5) Electric Conductivity (S/cm)

Measurement by alternating current method: a membrane resistance measuring cell made of a platinum electrode and an LCR meter 3522 manufactured by HIOKI E.E. CORPORATION were used. An anion exchange membrane in a saturated and swelling state at room temperature in water was taken out and held between the platinum electrodes to measure membrane resistance (Rm) by impedance two minutes after being immersed in deionized water of 60° C. The electric conductivity of the anion exchange membrane was calculated by using the following formula.

κ=1/Rm·d/S

κ: electric conductivity of anion exchange membrane (S/cm)

d: thickness of anion exchange membrane (cm)

S: conducting area of anion exchange membrane (cm²)

Also, with regard to a produced anion exchange membrane, the survival rate (maintenance factor) of the conductivity after being immersed in 1 M-KOH heated to 60° C. for 10 days was examined to evaluate alkaline durability.

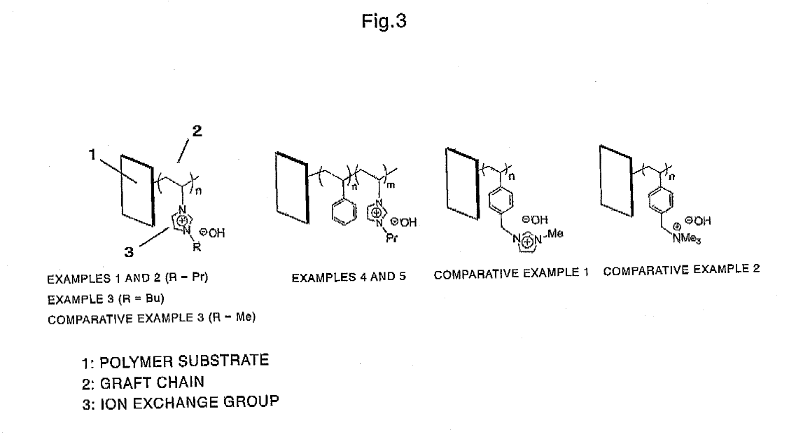

The graft chain composition, graft rate, IEC, water uptake, electric conductivity at 60° C., maintenance factor of electric conductivity after being immersed in 1 M-KOH heated to 60° C. for 10 days of the anion exchange membranes produced in Examples 1 to 5 and Comparative Examples 1 to 3 are shown in Table 1. Also, with regard to the anion exchange membranes produced in Examples 1 to 5 and Comparative Examples 1 to 3, a schematic view showing a relation of the polymer substrate, the graft chain and the ion exchange group is shown in FIG. 3. Incidentally, in FIG. 3, n and m each denote an integer of 1 or more.

TABLE 1

| | | | | | Electric | Mainte- |
|---|---|---|---|---|---|---|
| | | Graft | | Water | conduc- | nance |
| | Graft chain | rate | IEC | uptake | tivity | factor |
| | composition | % | meq/g | % | mS/cm | % |
| Example 1 | NVIm(Pr) | 52 | 1.78 | 58 | 23 | 95 |
| Example 2 | NVIm(Pr) | 80 | 2.54 | 73 | 34 | 92 |
| Example 3 | NVIm(Bu) | 52 | 1.70 | 58 | 20 | 94 |
| Example 4 | NVIm(Pr)/St | 85 | 2.01 | 78 | 46 | 100 |
| | (1:1) | | | | | |
| Example 5 | NVIm(Pr)/St | 120 | 1.82 | 40 | 35 | 98 |
| | (1:2) | | | | | |
| Comparative | CMS/MIm | 70 | 1.77 | 75 | 120 | 0 |
| Example 1 | | | | | | |
| Comparative | CMS/TMA | 70 | 1.81 | 114 | 160 | 90 |
| Example 2 | | | | | | |
| Comparative | NVIm(Me) | 51 | 1.92 | 59 | 80 | 13 |
| Example 3 | | | | | | |

It was capable of being confirmed from the results of Table 1 that any of the anion exchange membranes produced in Examples 1 to 5 was favorable in conductivity, water uptake property and alkaline durability.

With regard to the evaluation of alkaline durability, the maintenance factor of the electric conductivity of the anion exchange membrane (the membrane in which the imidazolium salt was introduced into the benzylic position) produced in Comparative Example 1 was 0%, and the maintenance factor of the electric conductivity of the anion exchange membrane (the anion exchange membrane having the methylvinylimidazolium salt) produced in Comparative Example 3 was 13%. On the other hand, the maintenance factor of the electric conductivity of the anion exchange membranes (the anion exchange membranes having the propylbutylvinylimidazolium salt or the butylvinylimidazolium salt in the graft chain) produced in Examples 1, 2 and 3 improved vastly to 95%, 92% and 94%, respectively. In addition, the maintenance factor of the electric conductivity of the anion exchange membranes (the anion exchange membranes having the cograft chain comprising the copolymer of N-vinylimidazole and styrene) produced in Examples 4 and 5 was 100% and 98% respectively, and it was capable of being confirmed that the copolymerization improved alkaline durability further. The anion exchange membrane (the anion exchange membrane in which the trimethylammonium salt was introduced into the benzylic position) produced in Comparative Example 2 exhibits a maintenance factor of 90%. However, the water uptake was so high that the membrane was incapable of maintaining the shape thereof. Any of the anion exchange membranes produced in Examples 1 to 5 was low in the water content and maintained the shape even 10 days after being immersed, and it was capable of being confirmed that any of them had sufficient strength.

1. An anion exchange membrane comprising a polymer substrate comprising a graft chain having an alkyl substituted imidazolium salt as an ion exchange group, wherein the graft chain is formed by N-alkylating an imidazole site of a polymer containing an N-vinylimidazole derivative as a polymerization unit with an alkyl halide with a carbon number of 3 or more.

2. The anion exchange membrane according to claim 1, wherein the graft chain is a polymer having a polymerization unit represented by the following formula (1): 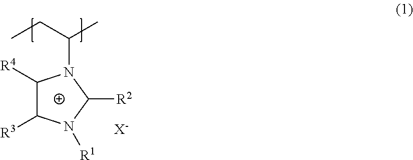
wherein, R¹ is an alkyl group with a carbon number of 3 or more; R², R³ and R⁴ may be each the same or different, and denote a hydrogen atom, a cyano group or a hydrocarbon group optionally having a substituent; and X⁻ is a negative ion.

3. The anion exchange membrane according to claim 1, wherein the graft chain is a copolymer further containing a comonomer as a polymerization unit.

4. The anion exchange membrane according to claim 3, wherein the polymerization unit of said comonomer is represented by the following formula (2): 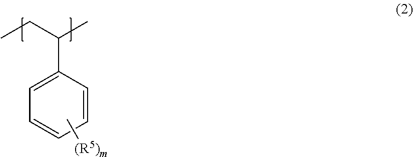
wherein, R⁵ denotes a hydrogen atom, a halogen atom or an alkyl group optionally having a substituent; m is an integer of 1 to 5; and when m is 2 or more, R⁵ may be the same or different.

5. A producing method of an anion exchange membrane comprising the following steps:
step A: step of graft-polymerizing an N-vinylimidazole derivative with a polymer substrate to introduce a polymer of said N-vinylimidazole derivative as a graft chain into said polymer substrate; and
step B: step of N-alkylating an imidazole site of said graft chain with an alkyl halide with a carbon number of 3 or more to form an alkyl substituted imidazolium salt.

6. The producing method of an anion exchange membrane according to claim 5, wherein said N-vinylimidazole derivative is a vinyl monomer having an imidazole ring capable of forming the alkyl substituted imidazolium salt by reacting with the alkyl halide.

7. The producing method of an anion exchange membrane according to claim 5, wherein said N-vinylimidazole derivative is a vinyl monomer represented by the following formula (3): 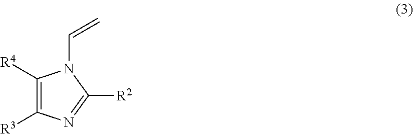
wherein, R², R³ and R⁴ may be each the same or different, and denote a hydrogen atom, a cyano group or a hydrocarbon group optionally having a substituent.

8. The producing method of an anion exchange membrane according to claim 5, wherein, in said step A, introducing a copolymer of said N-vinylimidazole derivative and a comonomer as the graft chain into said polymer substrate by graft-polymerizing said N-vinylimidazole derivative and said comonomer with the polymer substrate.

9. The producing method of an anion exchange membrane according to claim 8, wherein said comonomer is a vinyl monomer represented by the following formula (4): 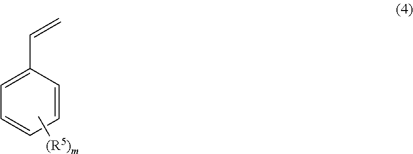
wherein, R⁵ denotes a hydrogen atom, a halogen atom or an alkyl group optionally having a substituent; m is an integer of 1 to 5; and when m is 2 or more, R⁵ may be the same or different.
